(19) United States
(12) Patent Application Publication
(10) Pub. No.: US 2024/0061170 A1
(43) Pub. Date: Feb. 22, 2024

(54) PHOTONIC INTEGRATED CIRCUITS AND LOW-COHERENCE INTERFEROMETRY FOR IN-FIELD SENSING

(71) Applicant: Meta Platforms Technologies, LLC, Menlo Park, CA (US)

(72) Inventors: Guohua Wei, Redmond, WA (US); Mohamed Tarek Ahmed El-Haddad, Redmond, WA (US); Marc Aurèle Gilles, Bridgewater, NJ (US); Robin Sharma, Woodinville, WA (US); Ruobing Qian, Kenmore, WA (US)

(73) Assignee: Meta Platforms Technologies, LLC, Menlo Park, CA (US)

(21) Appl. No.: 17/716,954

(22) Filed: Apr. 8, 2022

Related U.S. Application Data
(60) Provisional application No. 63/172,272, filed on Apr. 8, 2021.

(51) Int. Cl. G02B 6/12; G02B 6/42; G02B 6/122; G02B 6/124

(52) U.S. Cl. CPC G02B 6/12004; G02B 6/4214; G02B 6/1228; G02B 6/1245; G02B 2006/12159; G02B 2006/12147; G02B 2006/12102; G02B 2006/12121

(57) ABSTRACT

There is provided a photonic integrated circuit configured for low-coherence interferometry and in-field sensing. The photonic integrated circuit can include an opto-coupler that has a substrate substantially transparent to a specified wavelength of light and a waveguide configured to route a light beam having a center wavelength at the specified wavelength. The opto-coupler further includes a mirror disposed at an angle, and the mirror is disposed on an angled surface of the substrate, the angled surface being proximate to an output end of the waveguide. The opto-coupler further includes a beam forming element configured to collect light reflected from the mirror, and the waveguide and the mirror are integrated within the substrate.

### CROSS-REFERENCE TO RELATED APPLICATIONS

This application claims benefit to U.S. Provisional Patent Application No. 63/172,272 filed on Apr. 8, 2021, the disclosure of which is incorporated herein in its entirety by reference.

### FIELD OF TECHNOLOGY

The present disclosure relates generally to photonic integrated circuitry, and more particularly, low-coherence interferometry and methods and systems thereof.

### BACKGROUND

Existing low-coherence interferometer (LCI) systems such as those that utilize optical coherence tomography (OCT) have been demonstrated using components based on photonic integrated circuit (PIC) technology. Specifically, the interferometer is typically built, for example, with silicon photonics, but the input/output couplers and optical scanning systems are based on free space optics, and the light source and detectors are coupled with off-chip components. This approach is impractical for applications where these systems need to be integrated in larger modules that require compactness and portability. One such application is in virtual reality or augmented reality headsets, which both require components to be small to provide user comfort without compromising functionality.

In yet another application relating to eye tracking systems such as those based on camera imaging and specular reflection of illuminators, typical LCI systems cannot readily be integrated. Since eye tracking systems rely chiefly on surface reflection and geometric modelling to locate the pupil and extract gaze directions, due to this simplified modelling, they typically provide limited accuracy. Furthermore, eye tracking systems are also limited in terms of power efficiency and form-factor, since the system has to support both the camera and the lens stack. Thus, integrating an LCI system in these eye tracking system would provide significant benefits in terms of accuracy and power savings by obviating the need for power-hungry imaging systems. Unfortunately, current LCI systems cannot be integrated in the afore-mentioned eye tracking systems as result of their high degree of modularity and bulkiness.

### SUMMARY

The embodiments featured herein help solve or mitigate the above noted issues as well as other issues known in the art. For example, and not by limitation, the present disclosure provides an apparatus based on LCI principles that can be realized with photonic integrated circuits for out-of-plane in-field sensing applications. The exemplary apparatus can include one or more interferometers, light sources, photodetectors and optical input/output couplers and beam shaping optics for out-of-plane detection and in-field sensing. The exemplary apparatus can be a fully integrated system that has a compact form factor and high see-through quality, which makes it integrable and usable in an AR or a VR headset or in an eye tracking system.

The embodiments and teachings presented herein feature a novel optical I/O coupler (also referred to herein as opto-coupler) for out-of-plane in-field sensing. These embodiments have reduced or negligible dispersion relative to the dispersion typically encountered in a broadband source (or a tunable wavelength source) used in conventional out-of-plane couplers such as grating couplers. The embodiments are further advantageous because of their high degree of integration. They can include refractive and diffractive components for beam shaping.

The embodiments further include fully integrated photonic integrated circuits that can include one or more of the above-noted I/O couplers. The embodiments can achieve depth detection. They can be used as standalone devices or in an array of LCI devices used in a matrix configuration. Furthermore, the present disclosure also describes novel fabrication methods with which the embodiments may be fabricated to achieve a high degree of integration.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIGS. 1A-1D illustrate several views of exemplary waveguides according to several aspects of the present disclosure.

FIG. 2. illustrates an opto-coupler according to several aspects of the present disclosure.

FIG. 3 illustrates another view of the opto-coupler depicted in FIG. 2.

FIG. 4 illustrates yet another view of the opto-coupler depicted in FIG. 2.

FIG. 5 illustrates another opto-coupler according to several aspects of the present disclosure.

FIGS. 6A-6B illustrate views of a metalens according to several aspects of the present disclosure.

FIGS. 7A-7C illustrate various implementations of photonic integrated circuits according to several aspects of the present disclosure.

FIG. 8 illustrates a fabrication process sequence according to several aspects of the present disclosure.

FIG. 9 illustrates a waveguide arrangement according to several aspects of the present disclosure.

FIG. 10 illustrates a waveguide arrangement according to several aspects of the present disclosure.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

Generally, an LCI system typically includes a broadband light source or a tunable light source. For example, and not by limitation, an LCI system that is included in an optical coherence tomography (OCT) system can require the use of such a broadband or tunable light source. The requirement for the source's spectral range depends on the detection resolution, and typically, it is from 10 nm to tens or hundreds of nanometers. Existing systems out-couple light from the sample arm and/or reference arm of an interferometer to free-space optics from the edges of the photonic integrated circuit chip where optical scanning is implemented. However, this approach requires complex packaging for micro-optical devices or the resulting form factor is too large to be used in a wearable device such as AR or VR glasses.

Furthermore, due to the required spectral bandwidth, an optical I/O coupler with negligible optical dispersion is required for applications such as AR and VR glasses. The embodiments described herein feature photonic out-of-plane coupling which overcomes the dispersion issues in typical out-of-plane couplers, such as gratings, and the embodiments include transparent substrates which are suitable for AR or VR glasses. Several exemplary embodiments are described in detail below as well as methods for fabricating and integrating their various components together to yield highly compact photonic integrated circuits.

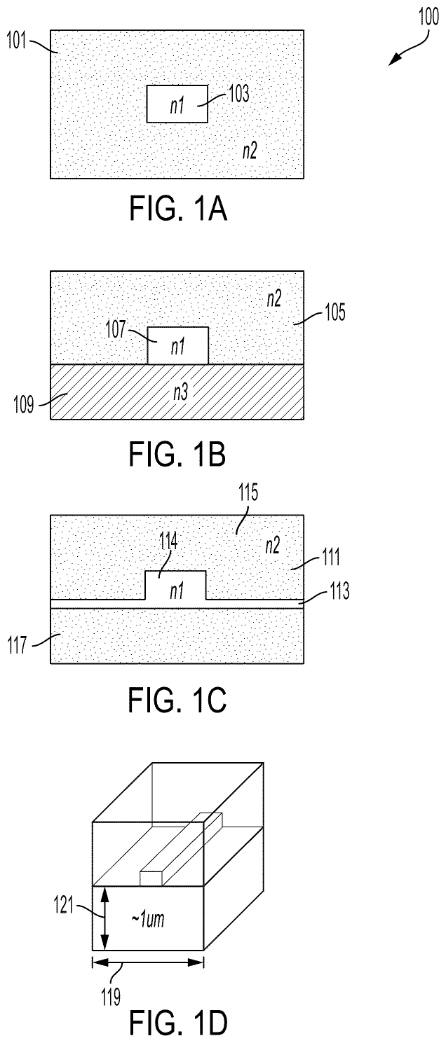

FIGS. 1A-1D illustrate various views and implementations 100 of waveguides that may be used in an exemplary embodiment. Generally, a waveguide as construed herein, may be a structure that has a cladding and a core. The cladding and the core may have different refractive indices. For example, the index of the core may be larger than the index of the cladding. Furthermore, the waveguide may be fabricated or micro-fabricated on top of a substrate. In some embodiments, the waveguide may be fabricated by creating a trench in a substrate and subsequently filling that trench with a material that has a different index of refraction than that of the substrate.

The waveguide may be made of a rigid material. For example, the waveguide may be made with deposited or grown thin film inorganic materials. In yet another implementation, the waveguide may be made on a flexible substrate, or it may be an optical fiber. In yet another implementation, the waveguide may include an optical fiber coupled to a light guiding element where the light guiding element is fabricated on a rigid or flexible substrate. The two portions, i.e., the optical fiber and the light guiding element may be interfaced using a coupler.

A waveguide that may be used in an exemplary embodiment can have a cross-sectional structure that is rectangular, circular, or elliptical, or it may have multiple cross-sections such as in the case of a tapered waveguide. In other implementations, the waveguide may be a single-ridged waveguide or a double-ridged waveguide. In yet other implementations, the waveguide may be a tapered waveguide. One of ordinary skill in the art will readily recognize that a waveguide that may be used in an exemplary embodiment can be structured in such a way to impart a desired waveguiding performance. For example, the waveguides may be structurally configured to have a specific propagation mode, such as, for example and not by limitation, a TE propagation mode or a TM propagation mode. Here, the act of structurally configuring the waveguide can include imparting a particular geometry to the waveguide and/or imparting a differential refractive index profile from cladding to core or from cladding to core to substrate.

As such, keeping in mind that the embodiments may make use of a wide variety of waveguide structures, FIGS. 1A-1D describe non-limiting examples of contemplated waveguides structures. For example, FIG. 1 illustrates a rectangular waveguide with a cladding material 101 of refractive index n2 and a core material 103 with refractive index n1, where n1 and n2 are different. Without loss of generality, n2 may be less than n1. Furthermore, also without loss of generality, the waveguide can have a gradient index from core to cladding.

FIG. 1B illustrates yet another waveguide structure. In this implementation, the rectangular waveguide includes a core material 107 having a refractive index n 1, a cladding material 105 with refractive index n2, and an underlying substrate 109 with a refractive index n3. All the refractive indices (n1, n2, and n3) may be different.

FIG. 1C shows yet another implementation of a waveguide according to an embodiment. In this implementation, the waveguide may include a core material that includes a first layer 113 from which a second layer 114 protrudes, both the first and second layers having a refractive index n1. The cladding material 111, with refractive index n2, can be disposed on top of the first layer 113 and on top of and around the second layer 113. The refractive index n1 and n2 can be different. Furthermore, the waveguide may include a substrate material 117 having a different index of refraction than n1 and n2 or an index of refraction equal to n2.

FIG. 1D shows a three-dimensional perspective view of a rectangular waveguide, such as the one described in FIG. 1B. Here, by example and not by limitation, the waveguide is shown to have a width 119 of 1 micrometer (m) and a height 121 that can be of the same order of magnitude as the width 119.

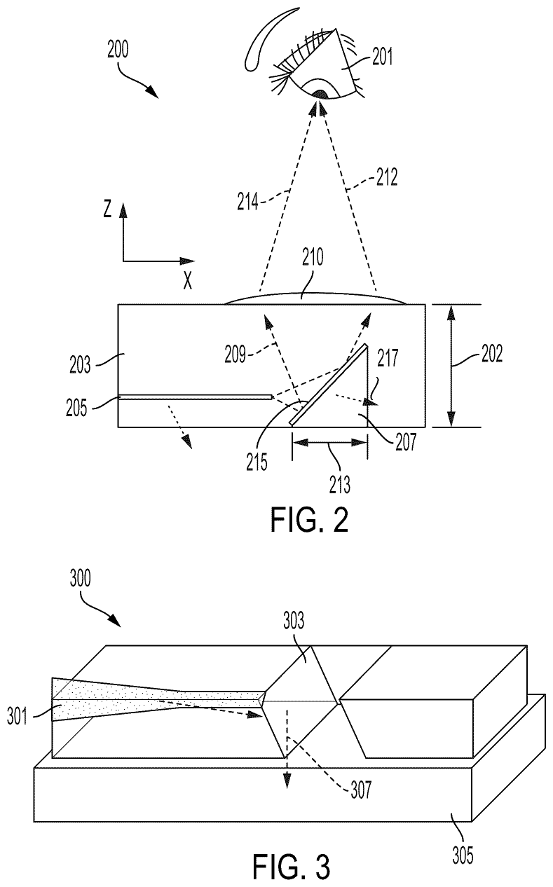

FIG. 2 illustrates a photonic integrated circuit (PIC)-based system 200 that can be configured for low-coherence interferometry and in-field sensing. The system 200 can be integrated as part of a virtual reality or as part an augmented reality headset, or generally as part of a smart headset. FIG. 2 depicts a headset and the relative positioning of a user 201 with respect to the headset. The focusing/beam-shaping achieved by the lens affects the signal-to-noise ratio and the resolution of the device.

They system 200 can include a substrate 203 of thickness 202 in which there is a fabricated-PIC. The substrate 203 can be selected to impart specific waveguiding properties and for light transmissivity. The PIC may include one or more waveguides 205. For example, and not by limitation, the one or more waveguide 205 may be configured as described above with respect to FIGS. 1A-1D. The substrate 203 may also have a mirror 215 disposed on a slanted surface 207 of the substrate 203. The base width 213 can be controlled to create a particular width for the slanted surface on which the mirror 215 is disposed. Without loss of generality, the mirror 215 may be deposited on the surface using a line-of-sight or a conformal deposition process.

For example, and not by limitation, the mirror 215 may be deposited via DC magnetron sputtering, thermal evaporation, or e-beam evaporation. The material deposited may be a material that has a high reflection coefficient. For example, the deposited material may be a metal such as gold, aluminum, or nickel. One of ordinary skill in the art will readily understand that gold deposition, or any metal deposition, as construed herein, does not preclude intermediate deposition steps of adhesion layers nor the usage of surface finishing techniques that may be used to enhance reflectivity or reduce surface roughness. Furthermore, additional patterning techniques such as lift-off or wet etching may be used to further define the mirror 215.

In the system 200, when a light beam is inputted into the one or more waveguides 205, the output beams of the one or more waveguides 205 hit the mirror 215 and reflect at an angle to produce the rays 209 which are then collected at the lens 210. It is noted that while a lens is shown as a light collection and focusing apparatus, generally, a beam-shaping optical component may be used. Depending on the application, the beam may be focused or it may not be focused onto an object/subject. Furthermore, while a human eye is shown as the object that is illuminated by the system 200, the object can generally be any target. However, when the object is a human eye, the system 200 is configured to illuminate the eye, but without the user 201 being able to visualize the beam itself.

In some embodiments, the mirror 215 may have non-negligible transmissivity by design, such that a fraction of the light can pass through the mirror 215 while the majority is reflected. This scenario is illustrated by the beam 217 being transmitted through the mirror 215. In such implementations, a detector may be placed behind the mirror 215 to collected the transmitted beam 217 in order to infer the intensity and/or temporal resolution of the light beam carried by the one or more waveguides 205.

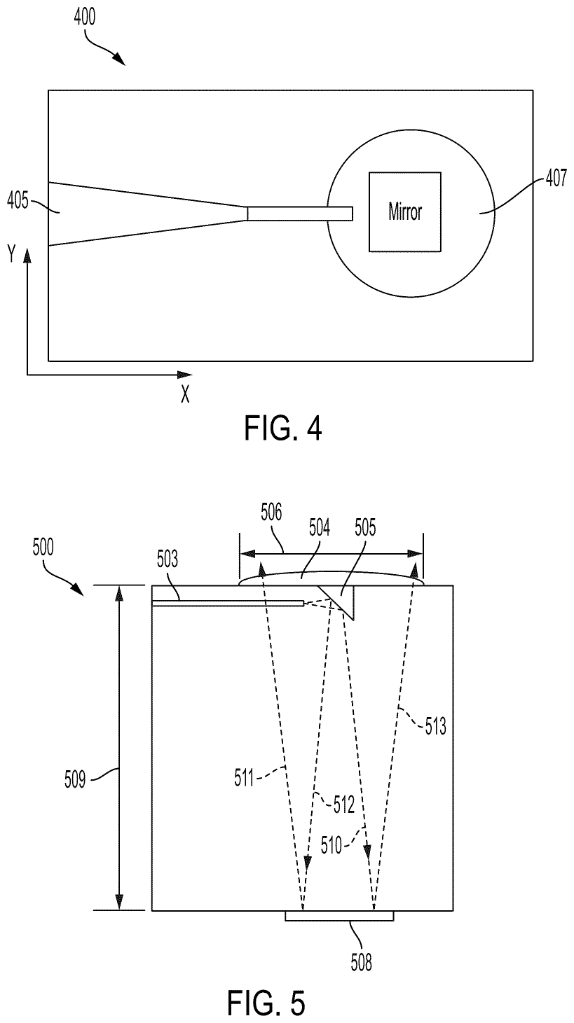

FIG. 3 illustrates a system 300 which is similar to the system 200. In the system 300 however, light in the photonic integrated circuit is inputted in one or more waveguides 301 that extend from behind a mirror 303, and the light is reflected in a direction 307 that is substantially perpendicular to the direction of propagation of the light in the one or more waveguides 301. The substrate 305 may be transparent or substantially transparent to the outputted light that is in the direction 307. FIG. 4 illustrates a top view 400 of a system like the system 200 or of the system 300. Here the one or more waveguides 405 may have a tapered cross-section. In other words, the one or more waveguide 405 may be tapered waveguides. A lens 407 may be disposed directly on top of the mirror.

FIG. 5 illustrates another photonic integrated circuit-based system 500 for performing low coherence interferometry. The system 500 can include one or more waveguides 503 configured to guide an input light beam to a mirror 505. On one side of the mirror 505, there may be disposed a lens 504 having a width 506. Similarly to the system 300 or the system 200, the system 500 can reflect the light beam in a desired direction based on the angle at which the mirror is disposed relative the direction of light propagation in the one or more waveguide 503. However, unlike in the system 200 or 300, in the system 300 the light beam is reflected through the substrate 509 (as indicated by the rays 510 and 512) towards a mirror 508. Upon hitting the mirror 508, the rays are again reflected (as indicated by the rays 511 and 513) towards the lens 504. The lens 504 then collects and focuses the received light.

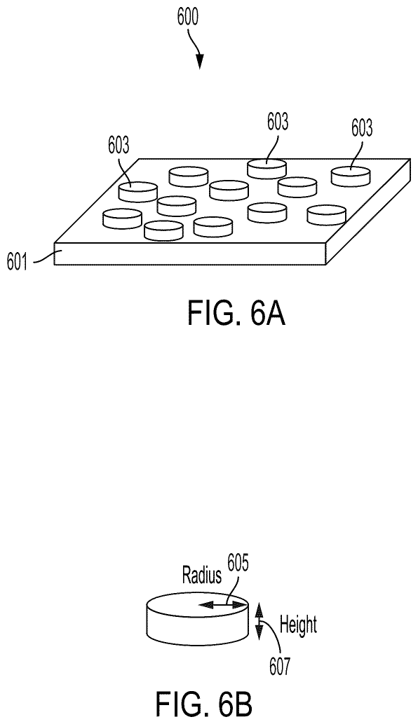

FIG. 6A illustrates a lens assembly 600 according to an embodiment. In the previously described exemplary systems, a single lens was used to focus the reflected light. In alternate implementations, the lens may be a metalens that is achieved using a plurality of nanostructures. Such nanostructures may be nano-antennas, wherein each nano-antenna may be a pillar or a cylindrical structure with varying height and/or radii. Alternatively, such nanostructures can be nanodisks, nanopillars, or a nanoposts. For example, and not by limitation, the lens assembly 600 may be implemented using a metalens 603 such as described above. Each one of the constitutive elements of the metalens 603 may be fabricated to have a radius 605 and a height 607 that can be selected to achieve specific beam-shaping performance.

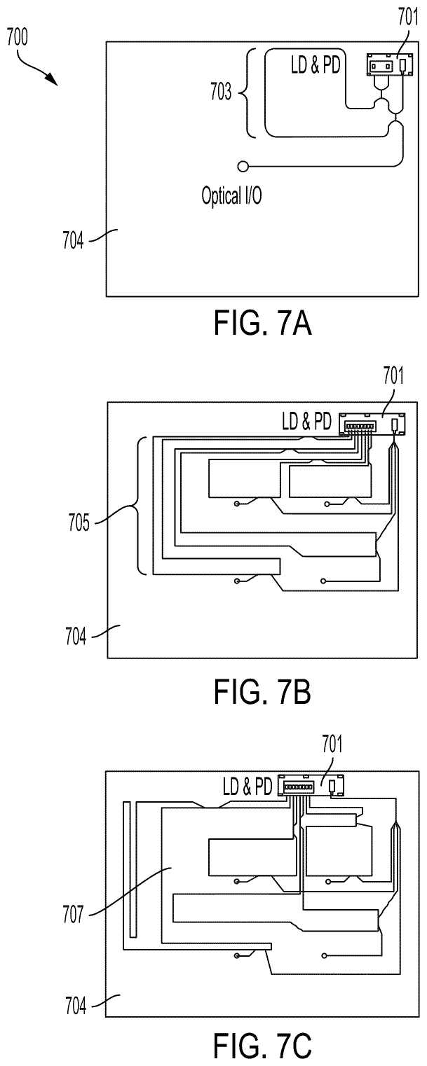

FIGS. 7A-7C illustrate various implementations of a photonic integrated circuit 700 that may be used for low-coherence interferometry and in-field sensing. In each exemplary implementation, the circuit 700 can include a light source and a photodetector co-integrated in a module 701 that is adjacent to various waveguides and mirror elements configured in a substrate 704. The various waveguides and mirrors may be configured as described previously. The light source may be a laser diode, or it may be a swept source. The photodetector may be a photodiode, an avalanche photodiode, or a single-photon avalanche photodiode. Furthermore, while FIGS. 7A-7C show the light source and the photodetector to be co-integrated, in other exemplary implementations, they may be placed at different locations.

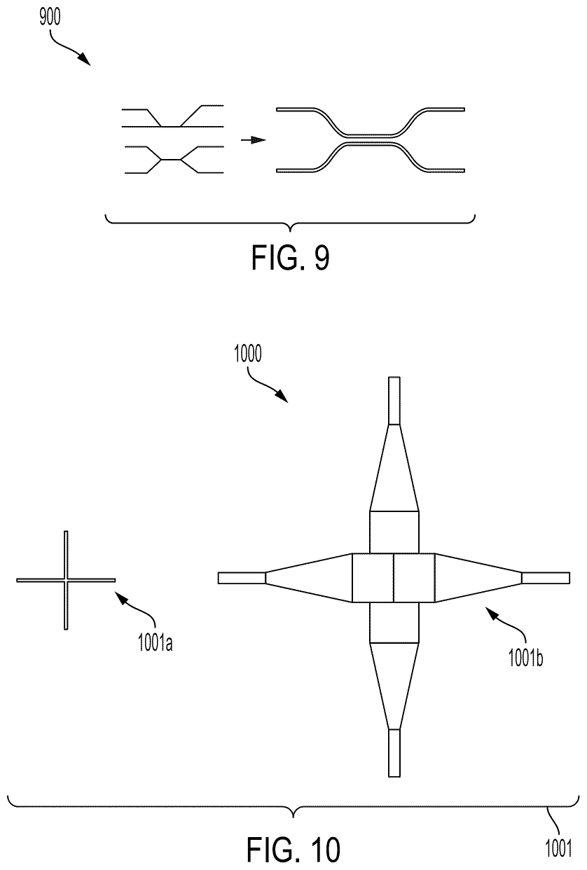

In the implementation 703 shown in FIG. 7A, the photonic integrated circuit may be implemented using a network of non-crossing or non-overlapping waveguides, and the photonic integrated circuit may also include a single optical input/output (I/O) port. In the implementation 705 shown in FIG. 7B, the photonic integrated circuit may have non-crossing waveguides, and it may include a plurality of optical I/O ports. Furthermore, in order to achieve more compact integration, overlapping or crossing waveguides may also be implemented. For example, as shown in the implementation 707 of FIG. 7C, crossing waveguides may be used to achieve a more compact photonic circuit. Non-crossing waveguides (900) and crossing waveguides (1000) and their corresponding circuit symbols are shown in FIGS. 9 and 10, respectively.

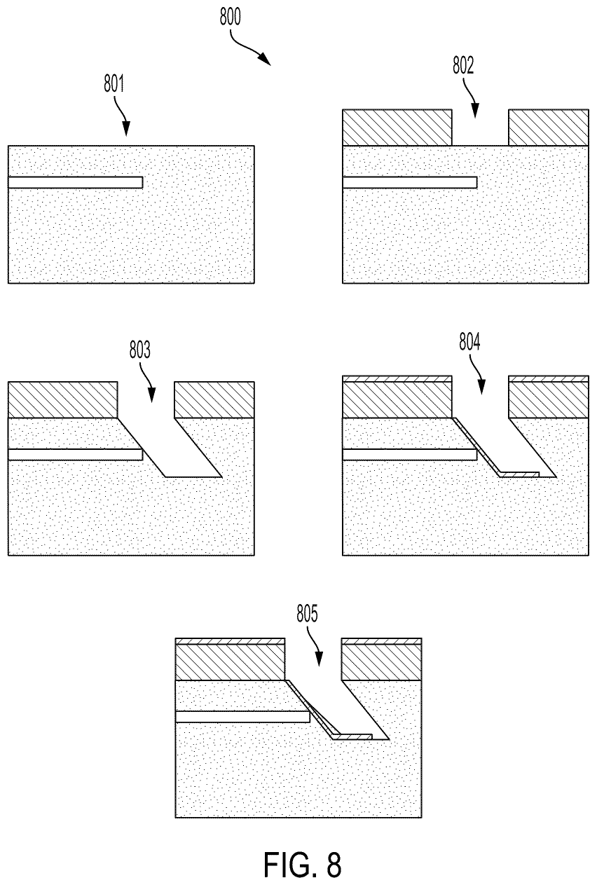

FIG. 8 illustrates a fabrication process sequence 800 according to an exemplary embodiment. The process sequence may start at a step 801 wherein there is provided a substrate with a waveguide integrated therein as described above. At a step 802, a photoresist (or generally a masking material) may be patterned to form an opening for a subsequent etching step. At a step 803, the process sequence 800 can include etching a cavity in the substrate in the area exposed by the patterned photoresist or masking material. The cavity may be formed by etching a trench in the substrate material, one sidewall of the trench being angled so that a mirror may further be deposited. Furthermore, the sidewall of the trench may be disposed proximate to the output end of the integrated waveguide. For example, and not by limitation, etching the trench may be achieved using a directional dry etching process, such as ion beam etching.

At a step 804, using a line of sight deposition process, a material may be deposited to fabricate the mirror on the sidewall of the trench. The material may be a metal for example, to provide a shiny surface for reflecting the light from the output waveguide at an angle towards a focus lens, as described previously in the context of FIGS. 2-4. Generally, the fabrication method may be compatible with CMOS and MEMS fabrication technologies.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. An opto-coupler, comprising:
a substrate substantially transparent to a specified wavelength of light;
a waveguide configured to route a light beam having a center wavelength at the specified wavelength;
a mirror disposed at an angle, wherein the mirror is disposed on an angled surface of the substrate, the angled surface being proximate to an output end of the waveguide; and
a beam forming element configured to collect light reflected from the mirror;
wherein the waveguide and the mirror are integrated within the substrate.

2. The opto-coupler of claim 1, wherein the waveguide includes a core with a first index of refraction and cladding with a second index of refraction, the first index of refraction being greater than the second index of refraction.

3. The opto-coupler of claim 2, wherein the substrate has a third index of refraction different than the second index of refraction and less than the first index of refraction.

4. The opto-coupler of claim 1, wherein the waveguide is tapered so that the width of the waveguide is gradually changed to effect a specified mode profile.

5. The opto-coupler of claim 1, wherein the mirror is a metallic coating.

6. The opto-coupler of claim 5, wherein the metallic coating has a thickness of about 200 nm.

7. The opto-coupler of claim 1, wherein the beam forming element is a refractive lens.

8. The opto-coupler of claim 7, wherein the refractive lens is made of dielectric material.

9. The opto-coupler of claim 8, wherein the dielectric material is either an inorganic material or an organic material.

10. The opto-coupler of claim 1, further comprising a second mirror disposed opposed the beam forming element on another side of the substrate.

11. The opto-coupler of claim 10, wherein the second mirror is configured to reflect the light reflected from the mirror towards the beam forming element.

12. A photonic integrated circuit, including a light source, a photodetector, an interferometer; and an opto-coupler, the opto-coupler comprising:
a substrate substantially transparent to a specified wavelength of light, comprising:
a waveguide configured to route a light beam having a center wavelength at the specified wavelength;
a mirror disposed (i) at an angle and (ii) on an angled surface of the substrate, the angled surface being proximate to an output end of the waveguide; and
a beam forming element configured to collect light reflected from the mirror, the waveguide and the mirror being formed in the substrate.

13. The photonic integrated circuit of claim 12, wherein the light source is a tunable laser.

14. The photonic integrated circuit of claim 13, wherein the tunable laser includes a gain section formed after the laser material is bonded to the substrate.

15. The photonic integrated circuit of claim 14, wherein the gain section is formed from the III-V material of the tunable laser and the substrate being bonded together.

16. The photonic integrated circuit of claim 12, wherein the photodetector and the light source are formed on the same chip.

17. The photonic integrated circuit of claim 16, wherein the photodetector is either a photodiode, an avalanche diode, or a single-photon avalanche diode.

18. The photonic integrated circuit of claim 12, wherein the interferometer is a Mach-Zender interferometer or a Michelson interferometer.

19. The photonic integrated circuit of claim 12, further comprising multiple waveguides, light sources, photodetectors, and interferometers.

20. An augmented reality headset or a virtual reality headset comprising a photonic integrated circuit, including a light source, a photodetector, an interferometer; and an opto-coupler, the opto-coupler comprising:
a substrate substantially transparent to a specified wavelength of light, comprising:
a waveguide configured to route a light beam having a center wavelength at the specified wavelength;
a mirror disposed (i) at an angle and (ii) on an angled surface of the substrate, the angled surface being proximate to an output end of the waveguide; and
a beam forming element configured to collect light reflected from the mirror, the waveguide and the mirror being formed in the substrate.
